(19) United States
(12) Patent Application Publication
(10) Pub. No.: US 2002/0063145 A1
(43) Pub. Date: May 30, 2002

(54) Reinforced hydroform tube

(76) Inventors: Steven R. Lotspaih, Cedarburg, WI (US); Robert Broman, Mequon, WI (US); Steve Lang, Mukwonago, WI (US); Muammer Koc, Mequon, WI (US)

Correspondence Address: Craig J. Lervick, Oppenheimer Wolff & Donnelly LLP, Plaza VII, Suite 3400, 45 South Seventh Street, Minneapolis, MN, 55402, US

(21) Appl. No.: 09/725,554

(22) Filed: Nov. 29, 2000

(51) Int. Cl. B23K 31/02; B21D 39/00

(52) U.S. Cl. 228/149; 228/144; 228/155; 228/158; 228/175; 228/173.6; 228/178; 228/187

(57) ABSTRACT

Selectively reinforced blanks are used in a hydroforming process to produce completed components having a predetermined shape and sufficient structural integrity to perform their desired function. To reinforce those components, reinforcing patches are added to the blank prior to hydroforming. Planar patches can be bonded to planar blanks or arcuate patches can be bonded to tubular blanks. In so doing, the hydroforming process produces a complete component, which does not require additional manufacturing steps to reinforce it. Additionally, by selectively using the reinforcing patches, the overall weight of the component is not unduly increased.

### BACKGROUND OF THE INVENTION

1. Field of the Invention

The present invention relates to an improved process for hydroforming various components. More specifically, the present invention relates to improving the strength and structural integrity of components formed through a hydroforming process.

2. Description of the Related Art

It is well known to form a variety of components through a hydroforming process in fields such as the automotive or plumbing industry. In general, hydroforming involves taking an enclosed blank and placing it into a hydroforming press. The press includes a die set which defines an interior cavity shaped to correspond to the desired exterior shape of the completed component. The enclosed blank is essentially surrounded by the press. Subsequently, each end of the enclosed blank is sealed. High pressure fluid is then introduced into the interior of the tubular blank. The pressure causes the blank to expand and conform its outer walls to the interior cavity of the press. Due to the consistent and uniform forces presented by the high pressure fluid, a transformation from an enclosed tubular to a completed component is made smoothly and evenly.

Hydroforming has many known advantages. Complexly shaped components can be made quickly and easily. Consistency is achieved by always introducing the same fluid pressure levels. The entire component is uniformly transformed, thus reducing stress levels that would occur during other types of bending or molding processes.

In the automotive industry, hydroforming components has gained widespread acceptance. Components ranging from cam shafts to frame body rails are now commonly manufactured through hydroforming. For various reasons, the process is appealing to this industry and results in high quality and desirable products. For example, since the same levels of pressure are simultaneously applied to all interior portions of the component, wall thinning during the transformation is minimized thus reducing potential weaknesses in the product. Fabrication of a component takes relatively little time and is essentially only dependent upon the amount of time required to increase the internal fluid pressure levels to the sufficient level. In general, hydroforming creates components having lower weights than traditionally formed parts. However, the strength and structural integrity remain the same or, in some cases, are higher than in the same traditional parts. The hydroformed component can have relatively complex shapes thus eliminating the need to attach multiple smaller pieces to form a completed component. This results in less labor being required to manufacture the part as well as the absence of various costly connective measures such as welding. Of course, by using the same die or press, the uniformity of manufactured parts is highly consistent and extremely repeatable.

While hydroforming is very beneficial for many applications, it is not without limitations. Special care must be taken during the hydroforming process to insure that walls are not excessively expanded. As would be expected, excessively expanding the walls of the tubular blank would result in very thin walls, which would be receptive to bending or collapsing. Potential for excessive expansion exists in areas that are substantially larger (in cross section) than the tubular blank. Also areas that have substantial bends or curves may be weakened during the hydroforming process.

Other completed components may have weaker areas due simply to their design or configuration. In many cases, these weakened areas will need to be reinforced after hydroforming is complete. This reduces some of the efficiencies of the hydroforming process in that it is labor intensive and requires the sometimes intricate attachment of smaller parts to the completed component. This can unduly complicate the process as previously mentioned. The very reason some of these components require strengthening is their complex overall shape. Thus, it becomes difficult to fabricate reinforcing portions which match or conform to the shape of the component. The completion of the assembly after the hydroforming process therefore unduly adds to the overall manufacturing burden.

Therefore, there exists a need to provide a system and method for hydroforming components that realizes all of the efficiencies of hydroforming, while minimizing burdens when reinforcing is required.

### SUMMARY OF THE INVENTION

The present invention provides for the calculated reinforcing of blanks that are later used in a hydroforming process to form a completed component. Prior to hydroforming, it is possible to determine which areas of the blank will form portions of the completed component having areas of relative structural weakness. Once so identified, those areas on the blank are then reinforced by affixing a reinforcing patch using any appropriate bonding method. For example, an appropriately shaped section of metal can be welded to the blank so that when completed, the component will have a thicker wall cross section in those areas that require it.

In hydroforming, a blank is typically prefabricated in a tubular form. That is, the blank is either extruded or otherwise manufactured to have a tubular configuration. In order to reinforce this type of blank, patches or reinforcing members are attached to this blank which is already tubularly configured.

In a second blank configuration, a planar member is cut and later rolled or bent into a substantially tubular shape. The planar blank offers advantages in that it is somewhat easier to attach the reinforcing material to a planar section than to a tubular section.

To reinforce planar blanks, the appropriate areas to be structurally reinforced are first identified based upon the configuration of the finished product. Subsequently, patches of metal or other appropriate reinforcing material are bonded to the planar blank through a process such as welding. The patches can be localized, having any shape, configuration, or size as required. It is also possible to provide a full width patch that will reinforce the completed component through its entire cross section over a given length. The reinforcing patches can be located on either the interior or exterior of the blank wherein the interior and exterior are defined by the final tubular configuration of the completed component.

For tubular blanks (as opposed to flat blanks), full width or localized patches can also be utilized. These patches can be bonded to the blank on either the interior or exterior. Due to its tubular configuration, it is beneficial to have the patches shaped to match the interior or exterior curvature of the blank to ease assembly burdens. If sufficient access is granted for inserting a localized or full width patch on the interior of a tubular blank, direct connection can be made by bonding or welding the patch to the interior of the blank. If such entry is not possible or practical, the localized or full width patch can be placed on the interior of the tubular blank and specialized welding processes can be used to bond the patch to the blank through the exterior of the blank.

In either event, a substantially tubular blank results having a reinforcing patch located either on the interior or the exterior of the blank. The blank is then placed into a hydroforming press where it is essentially enclosed about its outer circumference. In some cases, this process will generally cause the tubular blank to be compressed, bending it into a warped approximation of the interior shape of the press. Subsequently, the ends of the press and the tubular blank are sealed and fluid is introduced into the interior of the blank. As fluid pressure levels are increased, the blank is forced to evenly expand, matching the shape and configuration of the hydroform press. Since this occurs smoothly and evenly, uniform wall thickness is maintained during the transformation. Since the reinforcing portions are bonded to the blank, those portions also go through the same transformation due to fluid pressure levels. What results is a completed component having a desired shape and configuration wherein pre-selected areas have been structurally reinforced. Since only those areas that require it are reinforced, the process does not unduly increase the overall weight of the completed component.

It is an object of the present invention to selectively reinforce portions of a blank prior to hydroforming. This reinforcement then allows the finished product to meet all requirements for structural integrity and avoids weakness which could be created by having overly thin walls.

It is a further object of the present invention to allow flexible reinforcement of a product by utilizing planar blanks which are later rolled to form the desired tubular blank. By using planar blanks, reinforcement can easily be placed on either the interior or exterior of the blank.

Further objects and advantages of the present invention are more fully described in the following detailed description of the invention and the related drawings.

### BRIEF DESCRIPTION OF THE DRAWINGS

FIG. 1 is a perspective view of a planar blank having a plurality of local patches and a full width patch bonded thereto.

FIG. 2 is a schematic end view of a hydroform press in an open position with a tubular blank having reinforcing patches affixed thereto being placed into position.

FIG. 3 is a schematic end view of a hydroform press when a selectively reinforced tubular blank is partially compressed within the hydroform press.

FIG. 4 is a schematic end view of a hydroform press in a closed position wherein a tubular blank has been expanded to conform to the shape of the interior of the hydroform press.

FIG. 5 is a perspective view of the component formed from a hydroformed process wherein the component includes reinforcing patches.

FIG. 6 is a perspective view of a tubular blank having a full width patch attached to an exterior thereof.

FIG. 7 is a perspective view of a tubular blank having a full width and a local patch attached to an interior of a tubular blank.

FIG. 8 is a perspective view of a component formed from a hydroforming process including a full width interior patch.

[Do we want to shown an illustration with a “curved” finished product?]

### DETAILED DESCRIPTION

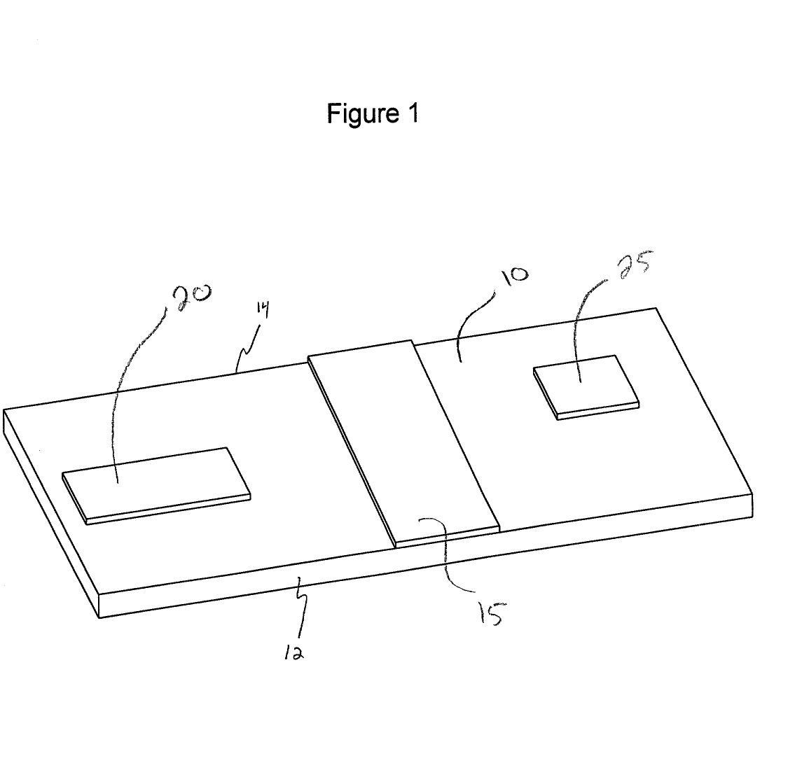

Referring to FIG. 1, a planar or flat blank is illustrated and generally referred to as 10. Flat blank 10 is formed from metal or other suitable material to be used in a hydroforming process. Prior to hydroforming, flat blank 10 will be rolled, bent, or otherwise transformed into a tubular structure. As this occurs, two opposite edges 12 and 14 of flat blank 10 will be brought together. These edges are then bonded together typically by a welding process. Once flat blank 10 has been rolled into a tubular configuration and hydroformed, it will form a completed component. That component may have areas which require structural reinforcements. Working backwards, those areas which require structural reinforcement can be identified when the component is in the configuration of flat blank 10. As illustrated, flat blank 10 has three areas where structural reinforcement was determined to be necessary.

Medially positioned on flat blank 10 is full width patch 15. Full width patch 15 is a section of metal having an appropriate thickness which has been bonded to flat blank 10, preferably by a welding process. Full width patch 15 extends across the entire width of flat blank 10. Thus, when flat blank 10 is rolled into a tubular blank, a full width patch will extend around the entire interior circumference of the formed tubular blank. Alternatively, it is completely acceptable to roll flat blank 10 into a tubular configuration in an opposite direction so that the reinforcing sections appear on the exterior portion of the tubular blank.

The term “tubular,” as used herein, is meant to identify any structure with a continuous cross section. This includes well known cylindrical tubes, along with other cross sectional configurations such as square, rectangular, oval, triangular, etc.

In addition to full width patch 15, two smaller patches, local patch 20 and local patch 25, have been bonded to flat blank 10. Again, this preferably occurs through an appropriate welding process. Any number, shape and configuration of patches can be used to reinforce desired sections of flat blank 10. Once all reinforcing patches are attached, flat blank 10 is transformed into a tubular blank. In the illustrated example, full width patch 15 and local patches 20 and 25 are positioned so that when a tubular blank is formed, they reside within an interior of that structure.

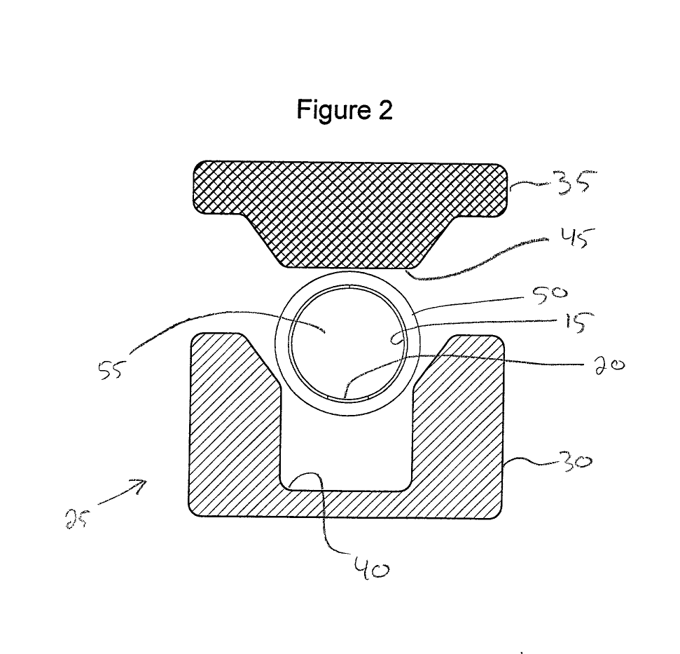

FIG. 2 illustrates an end view of a tubular blank 50. Tubular blank 50 is representative of any tubular blank with attached reinforced sections, including a blank that starts as a preformed tube, or a formed blank that is created from flat blank 10. Within tubular blank interior 55, full width patch 15 is visible extending around the entire interior circumference of tubular blank interior 55. In addition, local patch 20 is also visible from this end view. Tubular blank 50 is being positioned within a hydroforming press 25. More specifically, it is being positioned within a shaping cavity 40 having an interior configuration which approximates the exterior configuration of the desired component. Tubular blank 50 rests within a lower die 30 and is forced into position by the closure of an upper die 35 and, more specifically, an upper cavity wall 45 of upper die 35.

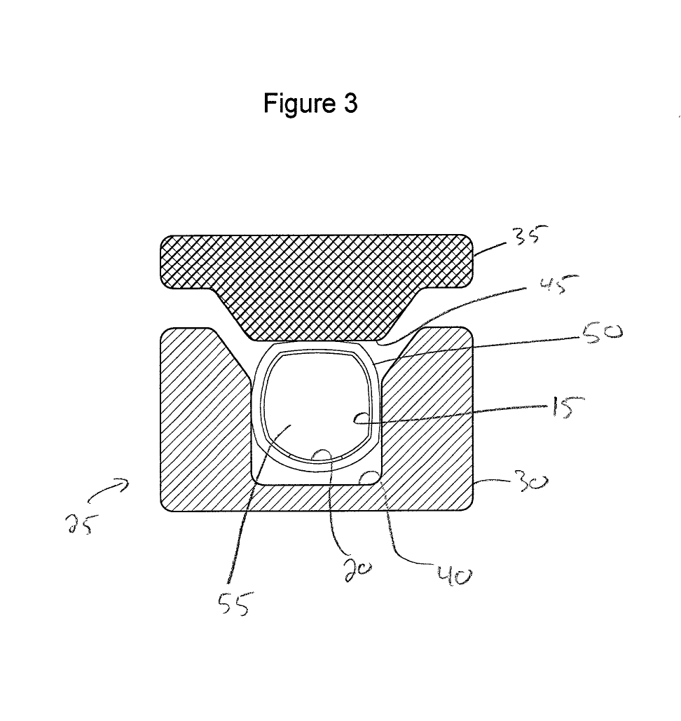

FIG. 3 illustrates how tubular blank 50 is being forced into shaping cavity 40 by upper die 35. As this occurs, the general shape of tubular blank 50 is being modified merely to accommodate its entrance into shaping cavity 40. That is, while tubular blank 50 is changing its shape in order to be moved into shaping cavity 40, it is not closely matching the shape of shaping cavity 40 either on an interior or exterior portion of tubular blank 50. In alternative configurations, tubular blank 50 is configured to easily fit within shaping cavity 40 without the need for mechanical compression. Once upper die 35 has been lowered all the way into place so that it is in physical contact with lower die 30, the ends of hydroforming press 25 are appropriately sealed. Fluid is then introduced by an appropriate mechanism (not shown) and fluid pressure within tubular blank interior 55 is increased to a desired level. This causes tubular blank 50, along with full width patch 15 and local patch 20 (and local patch 25, not visible in this view) to transform its shape to closely match that of shaping cavity 40.

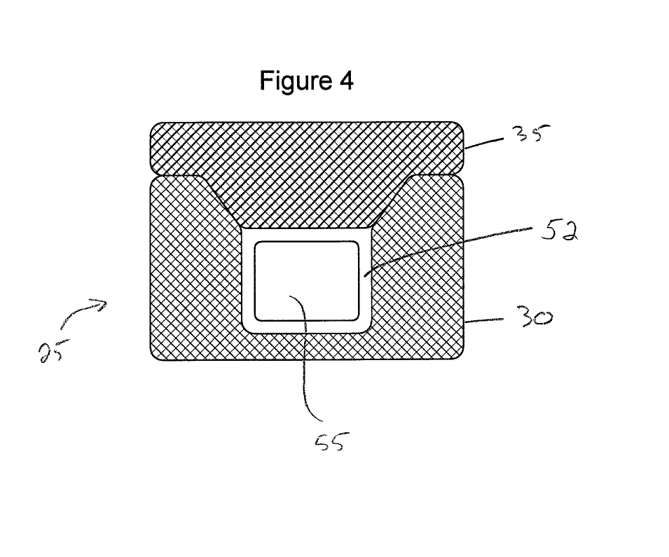

Thus, as illustrated in FIG. 4, tubular blank 50 (without the reinforcing patches being shown) has been shaped into a finished product 52 which will match the configuration of shaping cavity 40 both on an interior and an exterior area. Due to the nature of the hydroforming process and the fact that pressure has been evenly applied, the wall sections of finished product 52 are even and the transition areas are generally smooth. This is also true for the full width and local patches being employed. Once finished product 52 has been removed from hydroform press 25, it is a generally completed component. For illustrative purposes, the components shown have a relatively simple shape. It is to be understood that complex shapes including those where the cross section varies through its length can also be utilized within the context of the present invention.

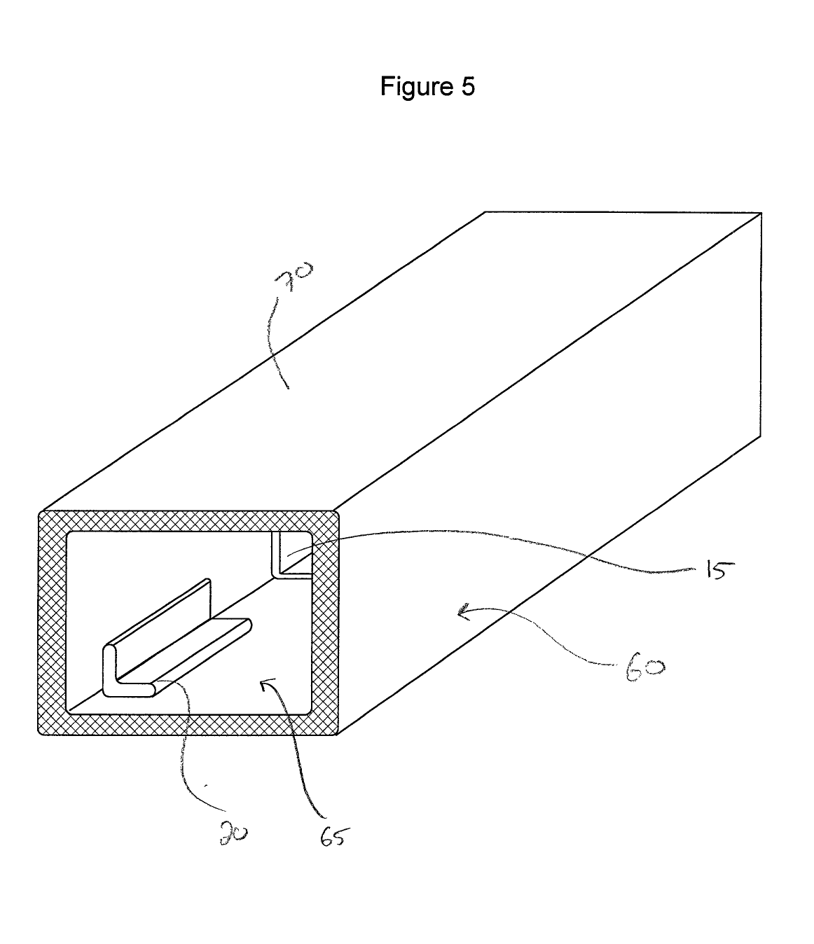

Referring to FIG. 5, a completed component is illustrated as hydroform tube 60. As shown within hydroform tube interior 65, local patch 20 and full width patch 15 are visible and have been appropriately shaped by virtue of their being bonded to the hydroform tube interior 65. The patches will provide structural reinforcement in those areas. Thus, hydroform tube 60, having gone through the same process as a non-reinforced tube, produces a completed component having the same tube exterior 70 as would a non-reinforced blank. However, by virtue of the interior patches, structural integrity is greatly increased and additional manufacturing steps are eliminated.

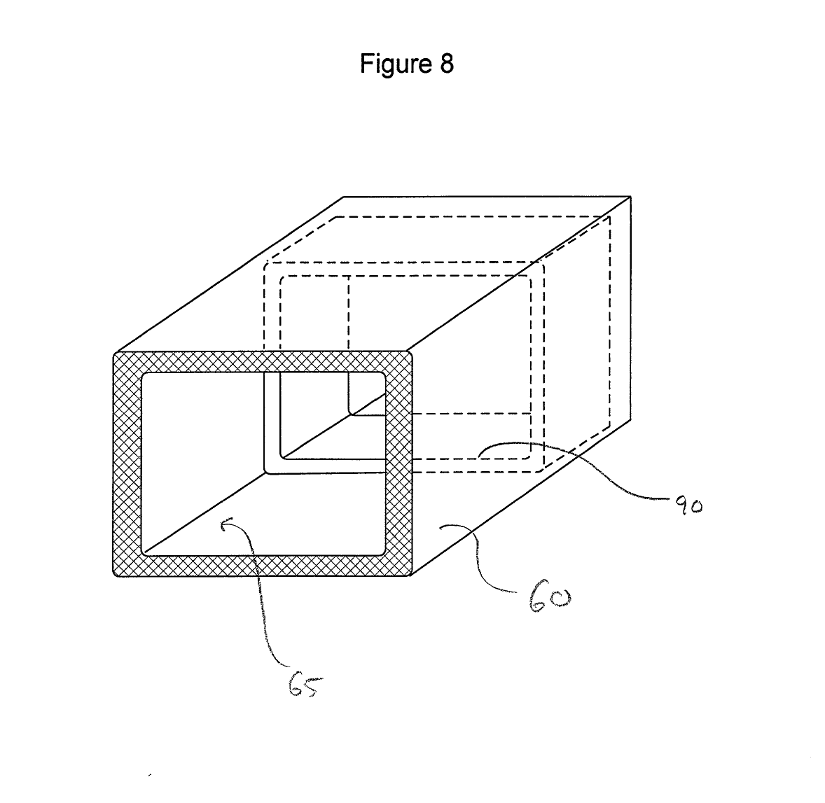

FIG. 8 illustrates a similar hydroform tube 60 having an interior full width patch 90 that is fully visible. As illustrated, interior full width patch 90 extends around an entire interior circumference of tube interior 65. Thus, in that section of hydroform tube 60, structural integrity and reliability has been greatly increased.

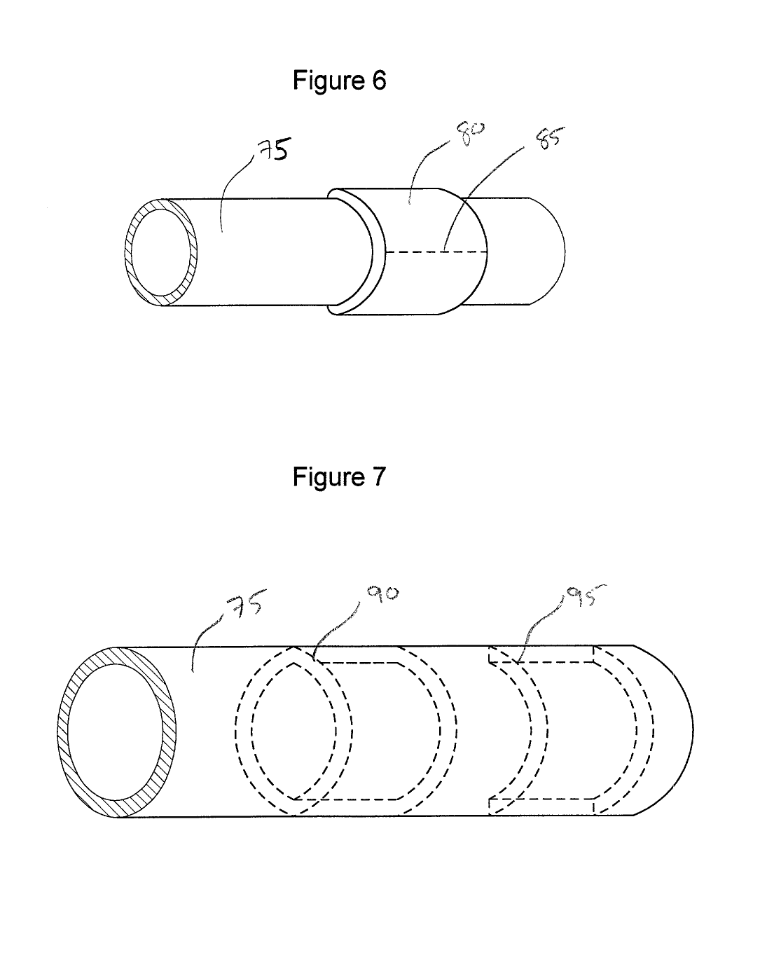

As previously explained, a manufacturer may receive preformed tubular structures to be used as blanks in the hydroforming process. Referring to FIG. 6, tubular blank 75 illustrates such a case. Depending upon the desired end result, it may be desirable to place an external full width patch 80 or any localized patch (not shown) on an exterior portion of tubular blank 75. External full width patch 80 is either preshaped to slide over an exterior circumference of tubular blank 75 or is appropriately wrapped or bent about tubular blank 75 to assume the configuration illustrated in FIG. 6. If not already an integral component, full width patch 80 may have a patch seam 85 where its two ends are joined. If desired, patch seam 85 can be welded by any known welding process. In addition, external full width patch 80 can be welded or otherwise bonded to tubular blank 75. Once so done, tubular blank 75 is ready for the hydroforming process. As opposed to placing external full width patch 80 within an interior tubular blank 75, when patch 80 is placed on an exterior, proper consideration must be given to the effect it will have on the hydroforming process. That is, tubular blank 75 no longer has a smooth exterior surface that will contact hydroform press 25. While not necessarily producing detrimental results, such an offset needs to be considered so that the proper completed component is achieved.

FIG. 7 illustrates how a tubular blank 75 would appear having an interior full width patch 90 and an interior local patch 95. Such patches could have been bonded in place when tubular blank 75 is in a planar format. Alternatively, if tubular blank 75 was delivered in a cylindrical configuration, interior full width patch 90 and interior local patch 95 could have been inserted thereto and bonded in place.

In general, the present invention provides for the attachment of reinforcing material to a blank structure that is used in the hydroforming process. Thus, when that structure is transformed during the hydroforming process into a completed component, the material added serves to strengthen and provide additional structural support to the completed component in the desired area. Any materials appropriate for forming blanks may be utilized. Similarly, any such material that can be bonded to the chosen blank material can be used as the reinforcing members. Any appropriate bonding process can be used to attach the reinforcing sections to the blank material. For example, traditional welding processes, lasers, GMAW electron beam friction and friction stir welding can all be used as appropriate. Of course, the transformation during the hydroforming process causes the blank material and the patch material to closely approximate one another. Thus, under the appropriate circumstances, a mere frictional engagement of these components may provide sufficient bonding between them for the desired completed component.

Additionally, the reinforcement may be used for many different purposes. Obviously, strengthening of components is a major reason for selective reinforcement. Alternatively, reinforcement may be used to control how components react during certain events, such as heavy loading or collision. Many other considerations may motivate the designer to selectively reinforce certain areas of hydroformed components.

Those skilled in the art will further appreciate that the present invention may be embodied in other specific forms without departing from the spirit or central attributes thereof. In that the foregoing description of the present invention discloses only exemplary embodiments thereof, it is to be understood that other variations are contemplated as being within the scope of the present invention. Accordingly, the present invention is not limited in the particular embodiments which have been described in detail therein. Rather, reference should be made to the appended claims as indicative of the scope and content of the present invention.

What is claimed is:

1. A method of hydroforming a component, comprising:
providing a planar blank having an upper surface and a lower surface;
bonding a reinforcing patch to an upper surface of the planar blank;
shaping the planar blank into a substantially tubular configuration with the reinforcing patch bonded to the planar blank; and
placing the tubularly shaped blank into a hydroforming press having an interior cavity with a predetermined shape, and increasing pressure levels within an interior of the tubularly shaped blank so that the tubularly shaped blank, including the reinforcing patch bonded thereto, is caused to transform to approximately match the predetermined shape of the interior cavity.

2. The method of claim 1 wherein shaping the planar blank is performed so that the upper surface of the planar blank forms an interior surface when in the tubular configuration.

3. The method of claim 1 wherein shaping the planar blank is performed so that the lower surface of the planar blank forms an interior surface when in the tubular configuration.

4. The method of claim 1 wherein bonding a reinforcing patch includes welding the reinforcing patch to the upper surface.

5. The method of claim 1 wherein the reinforcing patch extends across an entire width of the planar blank.

6. A method of hydroforming a component, comprising:
providing a tubular blank having an interior surface and an exterior surface;
bonding a reinforcing patch to an interior surface of the planar blank;
placing the tubular blank into a hydroforming press having an interior cavity with a predetermined shape, and increasing pressure levels within an interior of the tubular blank so that the tubular blank, including the reinforcing patch bonded thereto, is caused to transform to approximately match the predetermined shaped of the interior cavity.

7. The method of claim 6 wherein bonding a reinforcing patch includes welding the reinforcing patch to the interior surface.

8. The method of claim 6 wherein the reinforcing patch has a tubular configuration with an exterior circumference approximately equal to the an interior circumference of the tubular blank.

9. A blank for use in a hydroforming process, wherein the blank is transformed during the hydroforming process into a shaped component, comprising:
a generally planar metal member having an upper surface, a lower surface, a first edge and a second edge opposite from the first edge, wherein the planar member is capable of being shaped into a generally tubular configuration so that the first edge and the second edge are proximate one another and the upper surface forms an interior of the generally tubular configuration and the lower surface forms and exterior of the generally tubular configuration, wherein the tubular configuration is suitable for the hydroforming process; and
a reinforcing metal patch bonded to the planar metal member in a position determined to form a predetermined area of the shaped component requiring reinforcing, wherein the reinforcing metal patch is capable of being shaped with the generally planar metal member as the generally planar metal member is shaped into the generally tubular configuration and as the generally planar metal member is transformed during the hydroforming process into the shaped component so that the reinforcing metal patch reinforces the shaped component over the predetermined area.

10. The blank of claim 9, further comprising a welded seam joining the first edge to the second edge.

11. The blank of claim 9 wherein the reinforcing metal patch is bonded to the upper surface of the generally planar metal member so that when the generally planar metal member is shaped into a generally tubular configuration, the reinforcing metal patch is located within the interior of the generally tubular configuration.

12. The blank of claim 9 wherein the reinforcing metal patch is bonded to the lower surface of the generally planar metal member so that when the generally planar metal member is shaped into a generally tubular configuration, the reinforcing metal patch is located along the exterior of the generally tubular configuration.

13. A blank for use in a hydroforming process, wherein the blank is transformed during the hydroforming process into a shaped component, comprising:
a generally tubular metal member having an interior surface and an exterior surface, wherein the generally tubular metal member is suitable for the hydroforming process; and
a reinforcing metal patch bonded to the generally tubular metal member in a position determined to form a predetermined area of the shaped component requiring reinforcing, wherein the reinforcing metal patch is capable of being shaped as the generally tubular metal member is transformed during the hydroforming process into the shaped component so that the reinforcing metal patch reinforces the shaped component over the predetermined area.

14. The blank of claim 13, wherein the reinforcing metal patch has a generally tubular configuration with an exterior circumference approximating an interior circumference of the generally tubular metal member and the reinforcing metal patch is bonded to the interior of the generally tubular metal member.

15. The blank of claim 13, wherein the reinforcing metal patch has an arcuate shape having a curvature which approximates a curvature of a portion of the interior surface of the generally tubular metal member and the reinforcing metal patch is bonded to the interior of the generally tubular metal member.

16. The blank of claim 13, wherein the reinforcing metal patch has a generally tubular configuration with an interior circumference approximating an exterior circumference of the generally tubular metal member and the reinforcing metal patch is bonded to the exterior of the generally tubular metal member.

17. The blank of claim 13, wherein the reinforcing metal patch has an arcuate shape having a curvature which approximates a curvature of a portion of the exterior surface of the generally tubular metal member and the reinforcing metal patch is bonded to the exterior of the generally tubular metal member.
